(19) United States
(12) Patent Application Publication
(10) Pub. No.: US 2005/0120260 A1
(43) Pub. Date: Jun. 2, 2005

(54) Image forming apparatus and control method of an image forming apparatus

(75) Inventors: Kenji Suzuki, Ebina-shi (JP); Tomohiro Ono, Ebina-shi (JP); Takanori Masui, Ebina-shi (JP); Tomohisa Suzuki, Ebina-shi (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD

(21) Appl. No.: 10/883,778

(22) Filed: Jul. 6, 2004

(30) Foreign Application Priority Data
Nov. 19, 2003 (JP) 2003-389740

(51) Int. Cl. G06F 11/00

(52) U.S. Cl. 714/5

(57) ABSTRACT

An image forming apparatus is mounted with a replacement component having a storage device and includes a processing unit that controls operation of the image forming apparatus by executing a control program and a reading/writing device that writes and reads data to and from the storage device under control of the processing unit. The processing unit generates a command with an error detection code to be transmitted to the storage device and supplies the generated command with the error detection code to the reading/writing device. The reading/writing device performs an error detecting operation on the command with the error detection code received from the processing unit, and informs the processing unit of detection of an error if detecting the error by the error detecting operation and sends the received command with the error detection code to the storage device if not detecting an error by the error detecting operation.

### BACKGROUND OF THE INVENTION

1. Field of the Invention

The present invention relates to an image forming apparatus and, in particular, to writing and reading of data to and from a storage unit of a replacement component that is mounted in an image forming apparatus in a detachable manner.

2. Description of the Related Art

Image forming apparatus such as printers, copiers, digital multifunction machines, and facsimile machines are ones that can be mounted with replacement components such as a toner cartridge and a photoreceptor drum cartridge in a detachable manner. Further, a technique is now available that a replacement component is equipped with a nonvolatile storage medium for storing management data such as user information and a count indicating a degree of use of the replacement component (e.g., for printing of what number of sheets it has been used) and an image forming apparatus main body writes and reads management data to and from the nonvolatile storage medium.

Conventionally, access between a control circuit system of an image forming apparatus main body and the nonvolatile storage medium of a replacement component is made by wire. However, in the case of wired access, it is necessary to reliably engage a replacement-component-side terminal with a main-body-side terminal. For example, in the case of a replacement component of such a type as to be fixed to the main body by inserting the replacement component into the main body and then turning the former, the shape etc. of the replacement component are restricted strictly in designing it.

One method for solving the above problems is to utilize a wireless communication technology. For example, a system is known in which an RFID (radio frequency identification) tag (also called “non-contact IC card”) is attached to a replacement component and a reader/writer that is provided in an image forming apparatus main body performs reading and writing on the RFID tag. The employment of such a system makes the degree of freedom of designing higher than in the case of wired access.

Where wireless communication is utilized in the above-described manner, the probability that an error occurs in data that is exchanged with an RFID tag is relatively high because of introduction of noise on a communication channel. This requires such a countermeasure as error detection and subsequent retry processing. The detection of an error in transmission/reception data is prescribed in ISO 14443 and ISO 15693.

JP-A-9-69141 discloses a transmission data checking system. In this system, a reader/writer sends, to an RFID tag, transmission data that is a combination of a return request signal R and a control signal C. The RFID tag decrypts the data and returns resulting data to the reader/writer as return data. The reader/writer compares the return data with the transmission data and thereby checks whether correct data has been transmitted to the RFID tag.

JP-A-11-120305 discloses a non-contact IC card system. In this system, at the time of data writing, a reader/writer device sends an error correcting code (ECC) together with data and they are written to a data memory of a non-contact IC card. At the time of reading, the reader/writer device receives data and an ECC that are stored in the data memory and corrects for a code error that has occurred on a channel.

In an image forming apparatus, a reader/writer needs to be installed in such a range as to be able to communicate with the RFID tag of a replacement component and hence it is not always possible to mount the reader/writer on the same board as a CPU (central processing unit) is mounted that controls operation of the image forming apparatus. There may occur a case that the reader/writer is forced to be located away from the CPU and connected to the CPU by a communication line. The image forming apparatus includes various noise sources such as a high-voltage circuit for charging a photoreceptor and a transfer roll and a motor for driving an exposure system and a transport system. Therefore, noise may be introduced not only between the reader/writer and the RFID tag but also in the communication line between the CPU and the reader/writer. Where the reader/writer is located away from the CPU, the probability of receiving influence of a noise source between the CPU and the reader/writer is particularly high.

However, the above-described ISO 14443, ISO 15693, JP-A-9-69141, and JP-A-11-120305 are directed to the detection or correction of an error that occurs between the reader/writer and the RF tag and do not take into consideration a communication data error that occurs between the CPU and the reader/writer.

### SUMMARY OF THE INVENTION

The present invention has been made in view of the above circumstances, and provides an image forming apparatus and a control method of an image forming apparatus capable of lowering the frequency of occurrence of data destruction due to a communication error in a system in which an image forming apparatus main body writes and reads data to and from an RFID tag.

According to an aspect of the present invention, an image forming apparatus that is mounted with a replacement component having a storage device includes a processing unit that controls operation of the image forming apparatus by executing a control program; and a reading/writing device that writes and reads data to and from the storage device under control of the processing unit, wherein the processing unit generates a command with an error detection code to be transmitted to the storage device and supplies the generated command with the error detection code to the reading/writing device; the reading/writing device performs an error detecting operation on the command with the error detection code received from the processing unit, and informs the processing unit of detection of an error if detecting the error by the error detecting operation and sends the received command with the error detection code to the storage device if not detecting an error by the error detecting operation; and the processing unit executes a first prescribed recovery process if informed of detection of an error by the reading/writing device.

According to another aspect of the invention, a control method of an image forming apparatus that is mounted with a replacement component having a storage device and includes a processing unit that controls operation of the image forming apparatus by executing a control program and a reading/writing device that writes and reads data to and from the storage device under control of the processing unit, includes the steps of (a) the processing unit's generating a command with an error detection code to be transmitted to the storage device and supplying the generated command with the error detection code to the reading/writing device; (b) the reading/writing device's performing an error detecting operation on the command with the error detection code received from the processing unit; (c) the reading/writing device's informing the processing unit of detection of an error if detecting the error at step (b); (d) the reading/writing device's sending the received command with the error detection code to the storage device if not detecting an error at step (c); and (e) the processing unit's executing a first prescribed recovery process if informed of detection of an error by the reading/writing device.

According to the invention, the processing unit issues a command with an error detection code. The reading/writing device performs an error detecting operation on the command with the error detection code, and sends the command with the error detection code to the storage device of the replacement component as it is if not detecting an error. Therefore, a communication error can be detected not only in the path between the reading/writing device and the storage device of the replacement component but also in the path between the processing unit and the reading/writing device.

### BRIEF DESCRIPTION OF THE DRAWINGS

A preferred embodiment of the present invention will be described in detail based on the following figures, wherein:

FIG. 1 is a functional block diagram showing the configuration of an important part of an image forming apparatus according to an embodiment of the invention;

FIG. 2 is a block diagram showing an exemplary hardware configuration of a control unit of a reading/writing device;

FIG. 3 is a flowchart of a process that is executed by a CPU to write data;

FIG. 4 illustrates data transitions in a process that write command data for writing of data to an RFID tag is generated;

FIG. 5 is a flowchart of a process that is executed by the CPU to write data to the RFID tag at a single memory address;

FIG. 6 is a flowchart a process that is executed by the CPU to send one command data to the RFID tag;

FIG. 7 is a flowchart a process that is executed by the CPU to read data from a location having a single memory address of the RFID tag;

FIG. 8 is a flowchart of a process that is executed by a CPU to read data;

FIG. 9 is a flowchart showing a procedure of a check of read-out data; and

FIG. 10 is a flowchart showing a process that is executed by the control unit of the reading/writing device.

### DESCRIPTION OF THE PREFERRED EMBODIMENT

A preferred embodiment of the present invention will be hereinafter described with reference to the accompanying drawings.

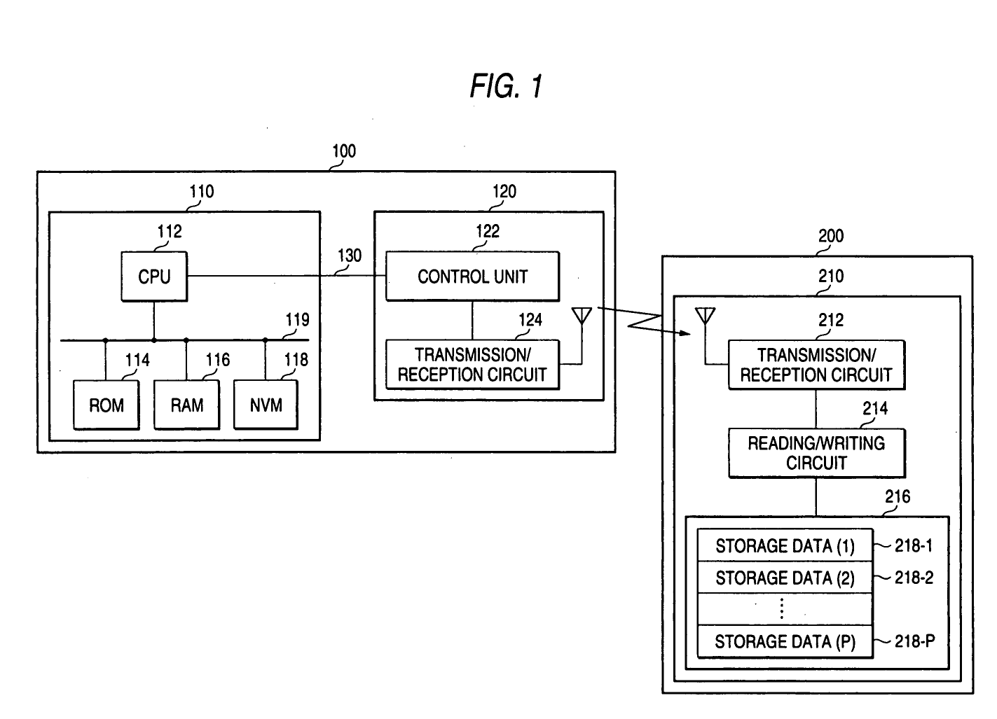

FIG. 1 is a functional block diagram showing the configuration of an important part of an image forming apparatus according to an embodiment of the invention. This image forming apparatus is such an apparatus as a printer, a copier, a facsimile machine, or a digital multifunction machine that is equipped with a mechanism for printing an image on a sheet of paper. Although various printing methods such as the electrophotographic method and the ink jet method are available, the invention does not depend on the printing method.

The image forming apparatus according to the embodiment is equipped with an image forming apparatus main body 100 and a replacement component 200. The image forming apparatus main body 100 is a substantially stationary part of the image forming apparatus and includes a case and a display and buttons for user interfacing. The replacement component 200 is a unit that can be mounted in the image forming apparatus 100 in a detachable manner and that is replaced when used up. Examples of the replacement component 200 are a toner cartridge, a photoreceptor drum cartridge, a development unit, and a fusing unit.

An RFID tag 210 is attached to the replacement component 200, and is used as a storage device for storing management data such as customer information and a degree of use of the replacement component 200 (e.g., for printing of what number of sheets it has been used). The RFID tag 210 is equipped with a transmission/reception circuit 212, a reading/writing circuit 214, a memory unit 216, etc. The memory unit 216 is a device for storing data and is equipped with a nonvolatile storage medium. The transmission/reception circuit 212 serves to perform a wireless communication with a reading/writing device 120 of the image forming apparatus main body 100 according to the RFID standard, and may be the same as a transmission/reception circuit of a conventional RFID tag. The reading/writing circuit 214 is a circuit for writing and reading data to and from the memory unit 216, and operates according to a command that is received from the image forming apparatus 100 via the transmission/reception circuit 212.

The memory unit 216 includes a ROM (read-only memory) area and an NVRAM (nonvolatile random access memory) area. The ROM area is a storage area whose storage data cannot be rewritten by a user, and a unique serial ID assigned to the RFID tag 210 is stored therein in a fixed manner. The NVRAM area is a rewritable, nonvolatile storage area and may be a storage area of an EEPROM (electrically erasable programmable read-only memory). The above-mentioned management data are stored in the NVRAM area. In this embodiment, data corresponding to the same management data is written to P locations (P: an integer that is greater than or equal to 2) in the memory unit 212 as storage data 218-1, 218-2, . . . , 218-P to secure redundancy and increase the safety of the data.

The image forming apparatus main body 100 is equipped with a control board 110 and a reading/writing device 120.

A CPU 112, a ROM 114, a RAM (random access memory) 116, and an NVM (nonvolatile memory) 118 are connected to a bus 119 on the control board 110. Control programs for operation control of the entire image forming apparatus 100 are stored in the ROM 114. The CPU 112 controls operation of the individual units of the image forming apparatus 100 by executing the control programs while using the RAM 116 as work area. Among those control programs is a program for processing of controlling the RFID tag 210 via the reading/writing device 120. The NVM 118 is a rewritable, nonvolatile memory, and information (e.g., set values of various control parameters and a count of print output sheets) to be stored for control and management of the image forming apparatus 100 is stored in the NVM 118.

The reading/writing device 120 is a device for writing and reading data to and from the RFID tag 210 of the replacement component 200 by radio communication, and is disposed close to a mounting location of the replacement component 200. The reading/writing device 120 has a control unit 122 and a transmission/reception circuit 124. The transmission/reception circuit 124 is a circuit for sending and receiving radio signals for wireless communications with the RFID tag 210. The control unit 122 is a circuit for controlling the transmission/reception circuit 124 to cause it to send or receive a signal to or from the RFID tag 210. Connected to the CPU 112 via a communication line, the control unit 122 exchanges data with the CPU 112 via the communication line. The transmission/reception circuit 124 may be a transmission/reception circuit of a conventional reader/writer.

In a conventional image forming apparatus of the above kind, when the CPU 112 sends an instruction to the reading/writing device 120, the reading/writing device 120 generates a command corresponding to the instruction, adds a CRC (cyclic redundancy check) code for a communication error check to the command, and sends a resulting command to the RFID tag 210. In contrast, in this embodiment, the CPU 112 generates a command with a CRC code for a communication error check that is generated by the reading/writing device 120 conventionally. That is, the CPU 112 generates command data that the RFID tag 210 will receive from the reading/writing device 120. The control programs stored in the ROM 114 etc. include a program for generation of such command data with a CRC code. When receiving a command with a CRC code that is sent from the CPU 112, the reading/writing device 120 performs a CRC check on the command to check whether a communication error has occurred between the CPU 112 and the reading/writing device 120. If no error is detected by this check, the reading/writing device 120 sends the command with the CRC code to the RFID tag 210 via the transmission/reception circuit 124 as it is.

Conversely, when receiving, from the RFID tag 210, a response (containing a CRC code) to a transmitted command, the reading/writing device 120 performs a CRC check on the response. If no error is detected by the check, the reading/writing device 120 passes the response data with the CRC code to the CPU 112 as it is. The CPU 112 checks whether a communication error has occurred between the reading/writing device 120 and the CPU 112 by checking the response data using the CRC code.

With the above configuration, error detection can be performed on the path between the CPU 112 and the reading/writing device 120 in addition to the path between the reading/writing device 120 and the RFID tag 210 on which error detection using a CRC code is performed conventionally. In addition, with this configuration, the CPU 112 generates a command with a CRC code itself to be sent from the reading/writing device 120 to the RFID tag 210. Therefore, it is not necessary to provide a circuit and a program for generating a CRC code in the reading/writing device 120, which means a merit that the reading/writing device 120 can be simplified in configuration.

In this embodiment, a CRC code is incorporated into data to be written to the memory unit 216 of the RFID tag 210 and resulting data is encrypted. That is, an encryption result of data with a CRC code is stored in the memory unit 216. This CRC code is added separately from a CRC code that is added to a command or a response (described above). Whereas the CRC code that is added to a command or a response is for detection of an error that possibly occurs in a communication channel, the CRC code that is added to data itself to be written to the memory unit 216 is for detection of destruction or falsification of the data itself after its storage in memory unit 216.

The embodiment will be described below in mode detail.

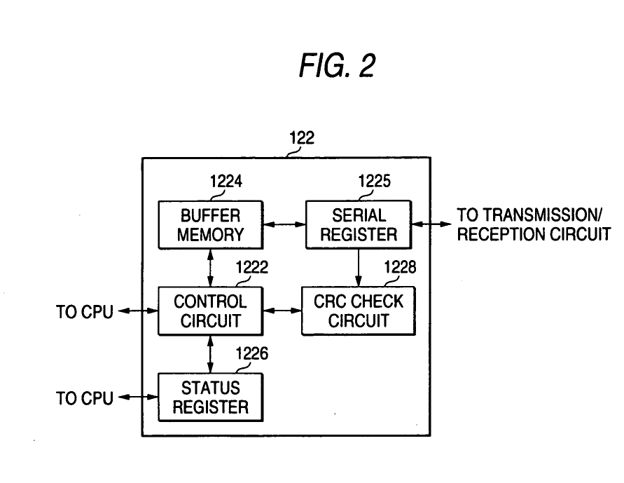

FIG. 2 is a block diagram showing an exemplary hardware configuration of the control unit 122 of the reading/writing device 120. As shown in FIG. 2, the control unit 122 is equipped with a control circuit 1222, a buffer memory 1224, a serial register 1225, a status register 1226, and a CRC check circuit 1228.

The buffer memory l224 is a FIFO (first-in first-out) memory for temporarily holding data received from the CPU 112 of the control board 110 and data received from the RFID tag 210. The serial register 1225 is a bidirectional serial register for switching between data arrangement order between the CPU 112 and the control unit 122 and that between the control unit 122 and the RFID tag 210. The CRC check circuit 1228 is a circuit for performing a CRC code check for detection of a communication error on a command received from the CPU 112 and a response to the command that is received from the RFID tag 210. The CRC check circuit 1228 performs a CRC error check on the basis of data in the serial register 1225. The status register 1226 is a register in which status information indicating a status of the reading/writing device 120 is registered. The CPU 112 on the control board 110 can read information in the status register 1226. The status register 1226 has bits that are pre-assigned to respective status items of which the CPU 112 should be informed. Examples of those bits are a bit indicating whether a CRC error has been detected in a command received from the CPU 112, a bit indicating whether a CRC error has been detected in a response received from the RFID tag 210, a bit indicating that a communication with the RFID tag 210 has not completed in a prescribed time (i.e., a time-out), a bit indicating that data received from the CPU 112 have overflowed the buffer memory 1224, a bit indicating that data received from the RFID tag 210 have overflowed the buffer memory 1224, and a bit indicating that the reading/writing device 120 is in a busy state (i.e., it is communicating with the RFID tag 210 and hence cannot accept a command that is sent from the CPU 112). The CPU 112 can recognize communication states between the CPU 112 and the reading/writing device 120 and between the reading/writing device 120 and the RFID tag 210 by reading values of the respective bits of the status register 1226 regularly, for example.

The control circuit 1222 is a circuit for controlling operation of the entire control unit 122. When receiving command data from the CPU 112, the control circuit 1222 inputs the data to the buffer memory 1224. In passing data in the buffer memory 1224 to the transmission/reception circuit 124, the control circuit 1222 first inputs the data in the buffer memory 1224 to the serial register 1225 and then supplies the data from the serial register 1225 to the transmission/reception circuit 124. At this time, the control circuit 1222 causes the CRC check circuit 1228 to perform a CRC check on the data in the serial register 1225. If an error is detected, the control circuit 1222 sets information indicating the error in the status register 1226.

Response data that is sent from the RFID tag 210 is received by the transmission/reception circuit 124 and input to the serial register 1225 after being converted into digital data. The control circuit 1222 stores the response data of the serial register 1225 in the buffer memory 1224. At this time, the control circuit 1222 causes the CRC check circuit 1228 to perform a CRC check on the data in the serial register 1225. If an error is detected, the control circuit 1222 registers information indicating the error in the status register 1226.

If a time-out has occurred in a communication with the RFID tag 210, the control circuit 1222 sets information indicating occurrence of a time-out in the corresponding bit of the status register 1226. As described above, the control circuit 1222 registers status information in the status register 1226 on the basis of a status of each unit of the control unit 122.

The above-described control unit 122 can be implemented as an ASIC (application-specific integrated circuit), for example.

Next, a description will be made of a processing procedure that the image forming apparatus follows in writing data to the RFID tag 210.

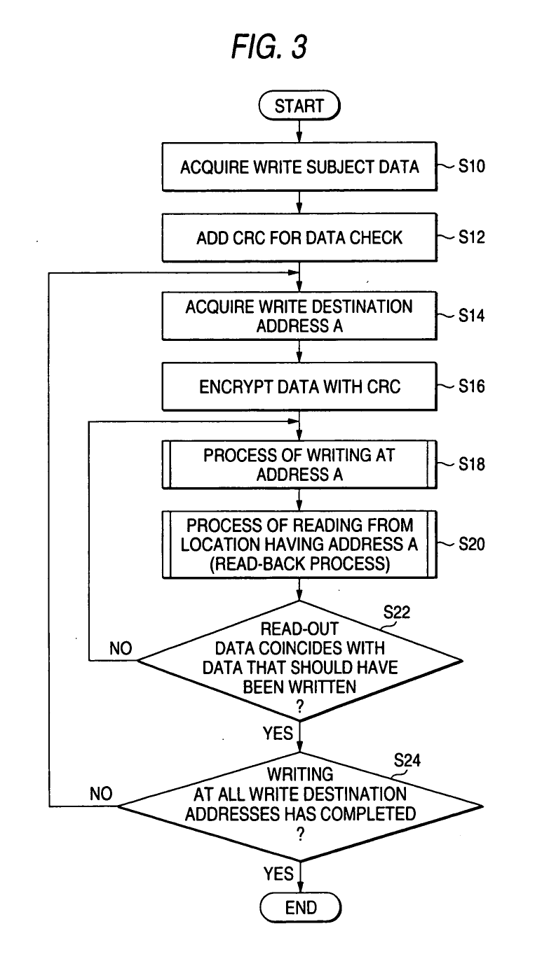

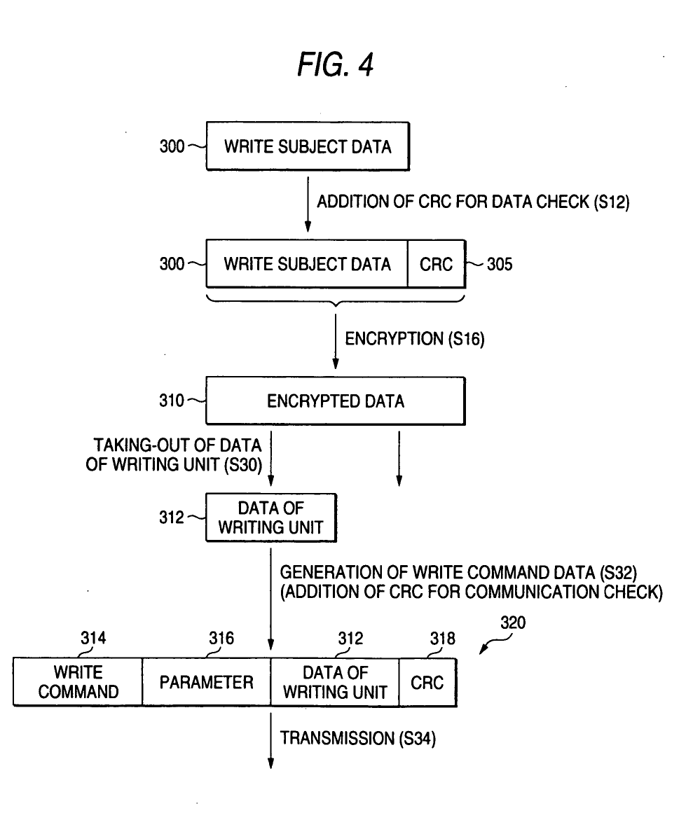

FIG. 3 is a flowchart of a process that is executed by the CPU 112 to write data. This process and other processes to be executed by the CPU 112 are described in the control programs that are held by the ROM 114. FIG. 4 illustrates data transitions in a process that write command data for writing of data to the RFID tag 210 is generated.

In a data writing process, first, at step S10, the CPU 112 acquires data (i.e., write subject data 300) to be written to the RFID tag 210. That is, when data writing timing has arrived, a routine corresponding to the process of FIG. 3 is called from the main routine of a control program and an address of the write subject data 300 on the RAM 116 or the NVM 118 is passed to this program. The write subject data 300 is data having a prescribed size. This size is a size that is determined for encryption process (described later) and that is necessary for attaining proper encryption strength (as is well known, the encryption strength lowers as the data size as the unit of encryption becomes smaller). The main routine calls the writing process routine of FIG. 3 for data of that size. If the size of data to be written is smaller than the prescribed size that is required from the encryption strength, write subject data 300 having the prescribed size is generated by, for example, giving a prescribed value (e.g., “0”) to each of bits having no data. At step S12, the CPU 112 calculates a CRC code 305 corresponding to the write subject data 300 and adds it to the write subject data 300. A CRC code 305 calculated should have a predetermined size.

At step S14, the CPU 112 acquires a write destination address (assumed to have a value A) in the memory unit 216 to which the data concerned should be written.

In this embodiment, the same write subject data 300 is written to P different locations in the memory unit 216 (P: an integer that is greater than or equal to 2). P write destination addresses corresponding to the single write subject data 300 and information indicating writing order for the P write destination addresses are stored in the ROM 114 or the NVM 118. At step S14, the CPU 112 takes out, one by one, the write destination addresses corresponding to the write subject data 300 according to the writing order from the ROM 114 or the NVM 118.

At step S16, the CPU 112 encrypts the write subject data 300 with the CRC code into encrypted data 310. As a preferred example of the encryption, this embodiment employs, as an encryption parameter, a write destination address value that was acquired at step S14. Examples of the manner of doing so are a method of generating an encryption key of the encryption on the basis of the write destination address and a method of generating an encryption initial vector on the basis of the write destination address in the case where a block encryption algorithm is used for the encryption. Since each write destination address is employed as an encryption parameter as described above, the values of encrypted data generated from the same write subject data 300 and to be written to the P locations are made different from each other. Therefore, the encrypted data are hard to break though the same write subject data 300 is written to the P locations. Information specific to the RFID tag 210 that is stored in the RFID tag 210 may be employed as an encryption parameter in addition to a write destination address. This increases the encryption strength because data having different values are written to different RFID tags 210 though the write subject data having the same values is written to those RFID tags 210. Examples of the data specific to the RFID tag 210 are a serial ID that is uniquely assigned to the RFID tag 210 and a vendor code (also called “OEM code”) indicating a vendor of the image forming apparatus. The serial ID is stored in the ROM area of the memory unit 216 of the RFID tag 210 in a fixed manner, and it is very difficult to alter the serial ID or copy it to another RFID tag. Therefore, employing the serial ID as an encryption parameter is very effective in preventing an illegal conduct. The serial ID or the vendor ID is read out and stored in the RAM 116 or the NVM 118 in a reading process that is executed when the replacement component 200 is mounted in the image forming apparatus main body 100 or when power is applied to the image forming apparatus main body 100 in which the replacement component 200 is mounted.

At step S16, the encryption may employ either of a public key algorithm or a common key algorithm.

After completion of the encryption of the data, at step S18 the CPU 112 executes a process for writing the thus-obtained encrypted data 310 to the RFID tag 210 at the address A. This writing process will be described later in detail.

After completion of the writing at the address A, at step S20 the CPU 112 performs a process (read-back process) of reading the data that has just been written from the location having the address A in the RFID tag 210. The read-back process is to check whether the correct data has been written to the RFID tag 210. The read-back process will also be described later in detail.

When the data that has been written to the RFID tag 210 at the address A is read out at step S20, at step S22 the CPU 112 compares the read-out data with the encrypted data 310 at step S18 that should have been written to the RFID tag 210.

If they do not coincide with each other, it means that incorrect data has been written to the RFID tag 210. Therefore, the CPU 112 returns to step S18, where the CPU 112 again writes the same encrypted data 310 to the RFID tag 210 at the same address.

On the other hand, if they coincide with each other at step S22, it means that the correct data has been written to the RFID tag 210, that is, this time the writing at the address A was successful. In this case, at step S24 the CPU 112 judges whether writing at all the P write destination addresses corresponding to the write subject data 300 has completed. If not, the CPU 112 returns to step S14, where the CPU 112 takes out the next write destination address. And the CPU 112 executes steps S16-S24 again. If it is judged at step S24 that writing to all the P locations has completed, the entire writing process for the given write subject data 300 is finished.

In the above example, at step S22 read-back data is checked on a level of the encrypted data 310. An alternative check may be such that read-back data is decrypted and whether it is correct data is judged on a level of the raw write subject data 300.

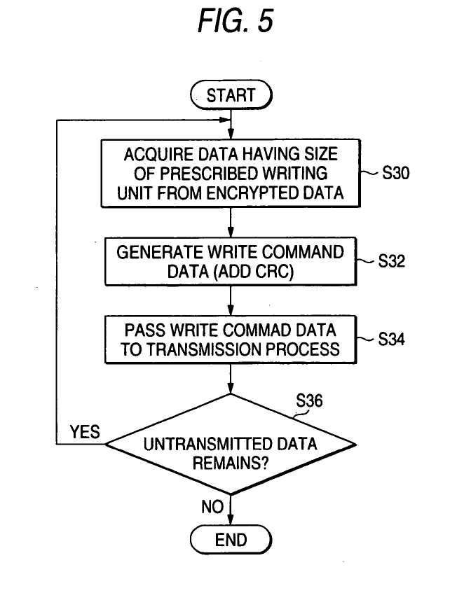

Next, the process for writing data at a single specified address A (step S18 in FIG. 3) will be described in detail with reference to FIG. 5. Also refer to FIG. 4 which is also relevant.

First, at step S30, the CPU takes out data 312 having a size of a prescribed writing unit from the encrypted data 310 that was generated at step S16. The size of data that can be written to the RFID tag 210 by a single radio transmission is restricted because, for example, the rate of data writing to an EEPROM is much lower than the processing rate of the CPU 112 and the rates of reading and writing on the RAM 116. The size of data that is written by a single radio transmission is the above-mentioned writing unit. On the other hand, as described above, to secure sufficient encryption strength, the size of encrypted data cannot be made too small. For these reasons, in this embodiment, encrypted data having a relatively large size is generated and then written by plural radio transmissions. The CPU 112 takes out parts of the encrypted data 310 in order from the head the writing unit at a time.

After the acquisition of the data 312 having a size of the writing unit, at step S32 the CPU 112 generates write command data 320 including the data 312. The write command data 320 is such that the data 312 having a size of the writing unit follows a code 314 meaning a write command and a parameter 316 of the writing such as the write destination address A and a CRC code 318 for all of the code 314, the parameter 316, and the data 312 follows the data 312. This command data complies with the format of a command to the RFID tag 210 that is prescribed in the standards ISO 14443 and ISO 15693. The added CRC code 318 is a code for communication error detection having a size of a prescribed number of bytes that is prescribed in those standards as a code to be added to communication data to be exchanged between a reader/writer and an RFID tag.

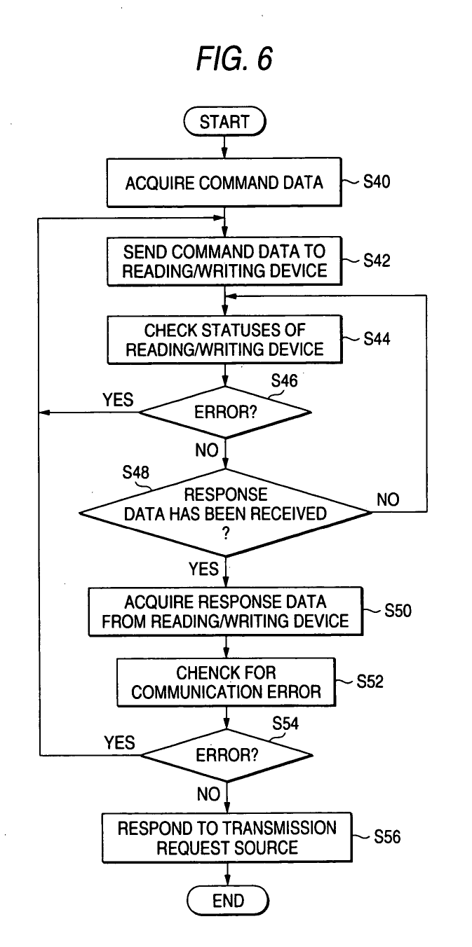

When the write command data 320 has been generated in the above-described manner, at step S34 the CPU 112 passes it to a transmission process routine of the control program. The transmission process (S34) will be described later in detail with reference to FIG. 6.

When the transmission of the write command data 320 corresponding to the data 312 of the writing unit that was taken out at step S30 has completed (step S34), at step S36 the CPU 112 judges whether all the encrypted data 310 has been sent. If there remain data that have not been sent yet, the CPU 112 returns to step S30 to execute the above steps again. If the transmission of all the encrypted data 310 has completed, the execution of the process of FIG. 5 is finished.

Next, the command transmission process that is executed by the CPU 112 will be described in detail with reference to FIG. 6. In this process, when receiving command data to be sent (step S40), at step S42 the CPU 112 sends it to the control unit 122 of the reading/writing device 120. After sending the command data, the CPU 112 reads the values of the status register 1226 of the control unit 122 of the reading/writing device 120 on a regular basis (step S44) and judges whether a communication error has occurred (step S46). If it is judged at step S46 that a communication error has occurred, the CPU 112 returns to step S42 to send the same command data to the reading/writing device 120 and executes the above steps again. A judgment result that a communication error has occurred is produced if, for example, the bit of the status register 1226 indicating whether a CRC error has occurred in data that was sent from the CPU 112 or the bits indicating whether a CRC error has occurred in data that was sent from the RFID tag 210 has a value that means detection of an error.

If the check of the status register 1226 does not produce a result to the effect that a communication error has occurred, at step S48 the CPU 112 further judges whether the reading/writing device 120 has received response data corresponding to the command data concerned from the RFID tag 210. If the reading/writing device 120 is configured in such a manner that when receiving response data correctly from the RFID tag 210 the control unit 122 of the reading/writing device 120 registers information to that effect in the status register 1226, the CPU 112 can judge whether reception of response data has completed by reading the corresponding value of the status register 1226. If the judgment result of step S48 is such that the reading/writing device 120 has not received response data, the CPU 112 returns to step S44 and performs a regular check of the status register 1226 again.

For example, if response data from the RFID tag 210 is in response to the write command data 320, the response data is data indicating whether the writing to the memory unit 216 has succeeded or failed and other statuses. Response data to read command data for reading data stored in the memory unit 216 includes the data read out.

If detecting that the reading/writing device 120 has completed reception of response data, at step S50 the CPU 112 acquires the response data from the buffer memory 1224 of the control unit 122 of the reading/writing device 120. The response data acquired by the CPU 112 at this time is data as generated by the RFID tag 210 having a CRC code that complies with the standard. The CPU 112 checks the response data using the CRC code (step S52) and judges whether an error has occurred (step S54). If the judgment result of step S54 is such that the response data has an error, the CPU 112 returns to step S42 and sends the same command data again. It can be judged that an error, if any, detected at this stage has occurred on the communication path between the control unit 122 and the CPU 112, because if a communication error had occurred when the data was sent from the RFID tag 210 to the reading/writing device 120 it would have been detected by the judgment of step S46. A modification is conceivable that if an error is found at step S54 the CPU 112 does not return to step S42 and, instead, reads the same response data from the buffer memory 1224. However, to implement this modification, the buffer memory 1224 needs to be of such a type as to be able to hold data that has been read from it instead of deleting it. When judging that response data has no communication error, the CPU 112 needs to instruct the control unit 122 to delete the response data from the buffer memory 1224.

If the judgment result of step S54 is such that the response data has no error, at step S56 the CPU 112 passes the response data to the program that called this transmission process routine.

In the above-described transmission process of FIG. 6, re-transmission (retry) of command data is repeated until the command data is transmitted to the RFID tag 210 without causing any error and response data to it is transmitted from the RFID tag 210 and reaches the CPU 112 without causing any error.

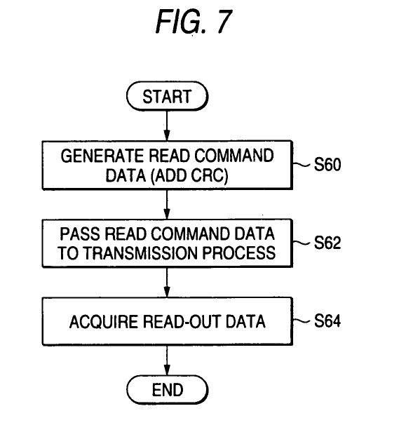

The process (step S20 in FIG. 3) for reading data from a location having a single address of the memory unit 216 of the RFID tag 210 will be described in detail with reference to FIG. 7.

In this process, first, at step S60, the CPU 112 generates read command data. The main body of the read command data is formed by a code meaning a read command and parameters such as a read destination address and a size of read data. Reading can be performed faster than writing, and hence the size of data that can be read out by one command transmission is larger than the size of data that can be written by one command transmission. Read command data is obtained by adding a CRC code to the main body. At step S62, the CPU 112 passes the read command data to the transmission process routine of FIG. 6. When the read command data has been transmitted to the RFID tag 210 by execution of the transmission process, data that meets the address and the size that are specified by the read command data is read from the RFID tag 210 and returned in such a form as to be incorporated in response data. At step S64, the transmission process routine takes out the data (encrypted data) that was read from the memory unit 216 by removing a header, the CRC code, etc. from the response data and passes the data to the reading process routine. The reading process routine passes the data to the routine that called the reading process.

In the case of the read-back process (step S20), the read-out data is returned to the process routine of FIG. 3 and subjected to the judgment step S22.

The process that is executed to write P encrypted data, generated from the same write subject data 300, to the P locations of the memory unit 216 of the RFID tag 210 has been described above.

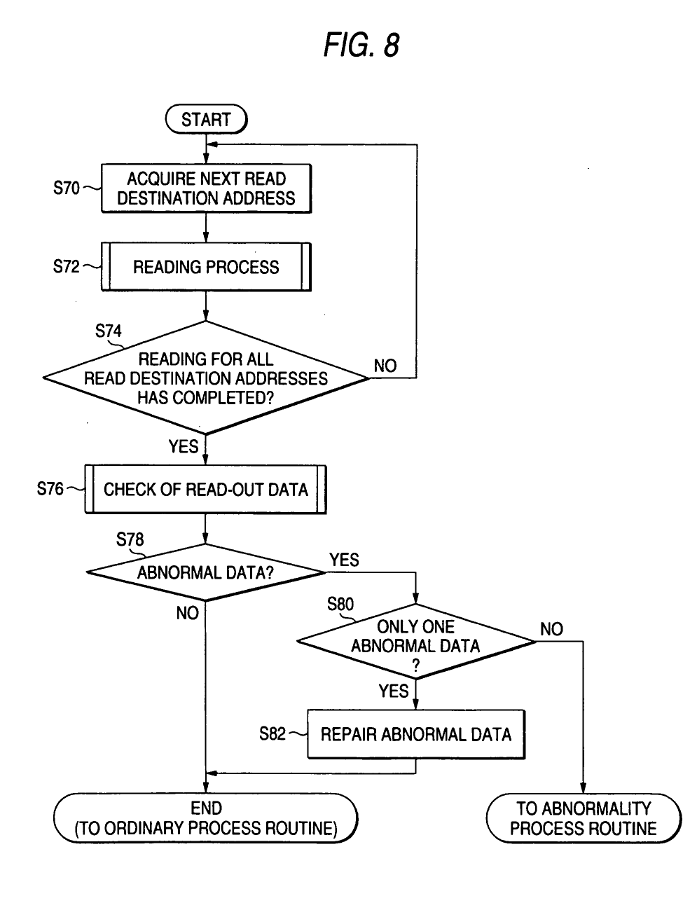

Next, a process that is executed when the CPU 112 reads single management data from the RFID tag 210. As described above, in this embodiment, encrypted data generated from the same data is stored in P locations of the memory unit 216. Therefore, P data are read out also in this reading process. The reading process will be described below with reference to FIG. 8.

A program that calls this process specifies identification information (e.g., a data item name) of data to be read out. When receiving such identification information, at step S70 the process routine of FIG. 8 reads P addresses (previous write destination addresses) of read subject data and information indicating their order from the ROM 114 or the NVM 118 on the basis of the identification information and takes out the P addresses in order one by one as read destination addresses according to the order information. At step S72, the process routine of FIG. 8 passes one of the P addresses to the read process routine of FIG. 7 and causes it to perform reading. The reading process routine passes, to the process routine of FIG. 8, as read-out data, encrypted data 310 that is read from the memory unit 216. The reading process routine has already been described above. In this embodiment, the reading process continues to be executed until all data stored in the memory unit 216 at the P addresses are read out (step S74).

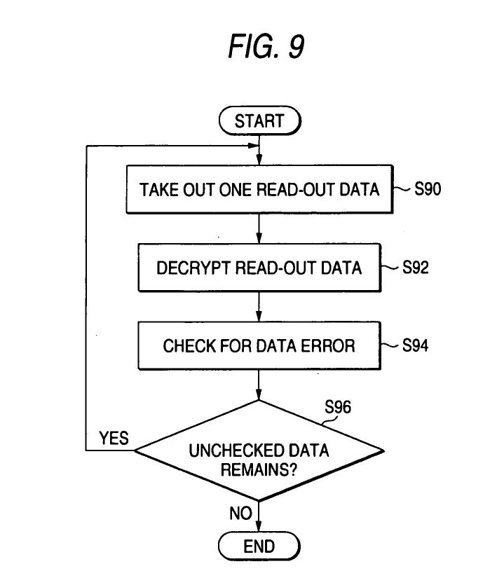

When all the data stored at the P addresses have been read out, at step S76 the CPU 112 performs error detection on the P read-out data using CRC codes 305 for a data check (see FIG. 4). FIG. 9 shows details of step S76. In this process, one of the P read-out data is taken out (step S90) and decrypted (step S92). Decryption corresponding to the encryption is performed by using, as a parameter, the address of the memory unit 216 where the read-out data concerned was stored (i.e., the read destination address acquired at step S70), in the same manner as in the encryption. Where the encryption employs, as a parameter, other unique data such as a serial ID, those data are also used in the decryption. The decryption produces write subject data 300 and a CRC code 305 added to it (see FIG. 4). At step S94, the CPU 112 performs error detection using the CRC code 305 as part of the decryption results. The above steps are repeated for all the P read-out data (step S96).

When all the P read-out data have been checked at step S76, at step S78 the CPU 112 judges whether check results include abnormal data, that is, error-detected data. If all the P read-out data are normal, the CPU 112 passes the data portion obtained by deleting the CRC code from the decryption result to the main routine of a control program that called this reading process and returns to an ordinary process. The execution of this reading process is finished here.

If judging that there are abnormal data (step S78), at step S80 the CPU 112 judges whether only one abnormal data exists. If judging that only one of the P read-out data is abnormal, at step S82 the CPU 112 repairs the abnormal data using one of the P-1 normal data (i.e., the data in which no error has been detected). The repairing is performed in the following manner. The CRC code is added to the normal data, and resulting data is encrypted by using the write destination address of the abnormal data as a parameter. Write command data to be used for writing resulting encrypted data to the memory unit 216 at the write destination address is generated and transmitted. On the other hand, if there are two or more abnormal data, the CPU 112 judges that fatal errors as caused by destruction or falsification of data in the RFID tag 210 have occurred and moves to a prescribed abnormality process routine.

The reason why repairing is performed if only one abnormal data exists and a judgment result “fatal errors” is produced if two or more abnormal errors exist is as follows.

In this embodiment, a communication error, if any, in all of the communication paths between the CPU 112, the reading/writing device 120, and the RFID tag 210 is detected and data that has been written to the RFID tag 210 is read back to check whether it is correct. If an error is detected in any of those operations, the data concerned is written again. Therefore, it is presumed that in an ordinary situation all data that have been written to the RFID tag 210 are correct. However, writing to the rewritable nonvolatile storage medium such as an EEPROM that is incorporated in the RFID tag 210 takes relatively long time, which leaves a probability that a carrier abnormality or the like causes a power shutoff between the reading/writing device 120 and the RFID tag 210 during writing and the writing fails. For example, if the replacement component 200 is pulled out during writing, data being written at that instant is destroyed. However, even in such an event, only the data being written is destroyed for the following reason. In this embodiment, each write subject data is written to P locations. Even if data is destroyed by pulling-out or the like of the replacement component 200 during writing, it is presumed that the destruction of data occurs only at one of the P locations and the data at the remaining P-1 locations are correct by virtue of the above-described data writing process according to this embodiment. Data at two or more locations are never destroyed simultaneously by such a manipulation as pulling-out of the replacement component 200 being subjected to writing. The above discussion leads to the following conclusion. In this embodiment, if an error is found in only one of P read-out data, it is probable that the data was destroyed by an ordinary operation such as pulling-out of the replacement component 200. Therefore, the error-detected data in the RFID tag 210 is repaired and the use of the replacement component 200 is permitted. In contrast, if an error is found two or more of the P read-out data, it is probable that the data were destroyed by the memory unit 216's being approaching the end of its life or the RFID tag 210's being damaged by external mechanical force or falsification of the data by a third party. Those errors are therefore handled as fatal ones. An example of the abnormality process to be executed at the occurrence of fatal errors is a process of prohibiting the image forming apparatus from doing such ordinary operations as printing and document reading in a state that the error-detected replacement component 200 is mounted.

For the following reason, it is preferable that repairing that is performed when only one abnormal data exists be performed by using a newer one of the remaining P-1 data. The order of writing of data to P locations has been determined as mentioned above. Therefore, if an ordinal position of the location of the abnormal data becomes known, it turns out that the data preceding the abnormal data are newer than the data following the abnormal data. For example, if the abnormal data is at the second location, it means that writing failed at the second location after writing to the first location succeeded and previously written data remain at the third and following locations. Therefore, it is appropriate to repair the abnormal data at the second location using the data that is read from the first location. If the abnormal data exists at the first or Pth (i.e., last) location, any of the data at the remaining P-1 locations can be used for repairing because those data were written in the same time interval.

The reading process of FIG. 8 for reading data from the RFID tag 210 is executed as part of a memory check process that is executed when, for example, power is applied to the image forming apparatus or a new replacement component 200 is mounted as a replacement.

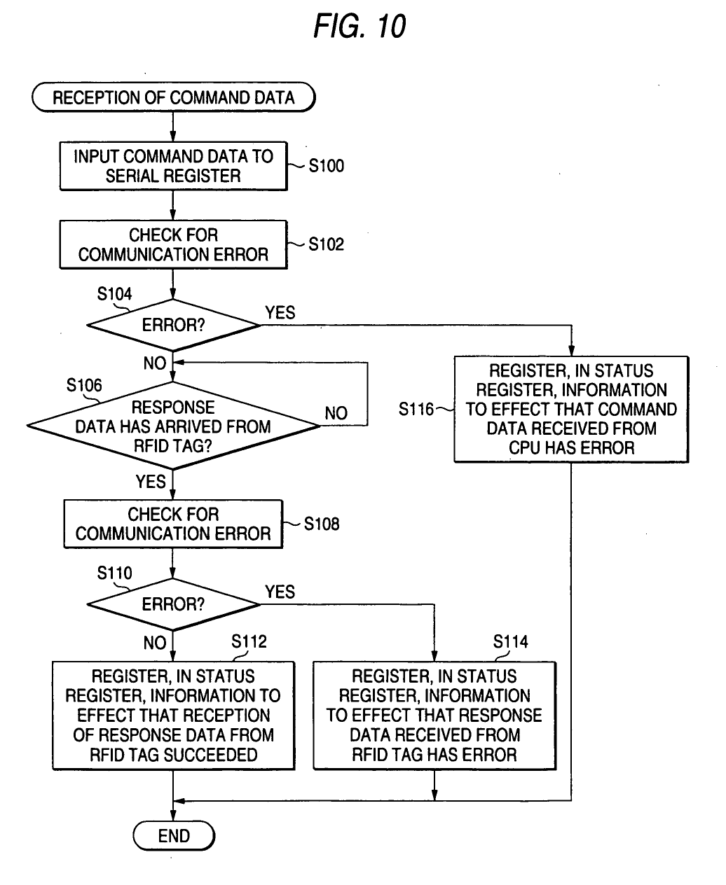

The processes that are executed by the CPU 112 have been described above. Next, the operation of the control unit 122 of the reading/writing device 120 will be described with reference to FIG. 10.

The reading/writing device 120 waits for arrival of command data from the CPU 112. Upon arrival of command data, the control unit 122 inputs the command data to the buffer memory 1224 and starts a process of FIG. 10. In this process, first, at step S100, the control unit 122 inputs the command data (e.g., write command data 320 shown in FIG. 4) in the buffer memory 1224 to the serial register 1225. Data in the serial register 1225 are supplied to the transmission/reception circuit 124 serially and sent to the RFID tag 210. During that course, at step S102, the CRC check circuit 1228 performs error detection on the command data in the serial register 1225 using the CRC code 318 for communication error detection. If an error is detected (step S104), at step S116 the control unit 122 registers, in the status register 1226, information to the effect that an error was found in the command data received from the CPU 112.

Then, the control unit 122 waits for response data that will be sent from the RFID tag 210 in response to the command data thus sent (step S106) When the control unit 122 receives response data from the RFID tag 210 via the transmission/reception circuit 124, the response data is first stored in the serial register 1225 and then transferred from the serial register 1225 to the buffer memory 1224. During that course, the control unit 122 causes the CRC check circuit 1228 to perform an error check on the response data in the serial register 1225 (step S108) and receives a check result (step S110). In this error check, a CRC code for communication error detection that is included in the response data is used. If no error is detected in this error detection, at step S112 the control unit 122 registers, in the status register 1226, information to the effect that the reception of the response data from the RFID tag 210 succeeded. The CPU 112 is monitoring the status register 1226. Therefore, When detecting that the control unit 122 has succeeded in receiving the response data, the CPU 112 acquires the response data from the buffer memory 1224. On the other hand, if an error is detected by the error detection, the control unit 122 at step S114 the control unit 122 registers, in the status register 1226, information to the effect that the response data received from the RFID tag 210 has an error. In response, the CPU 112 that is monitoring the status register 1226 executes a prescribed recovery process such as re-transmission (retry) of command data on the basis of the above information.

As is well known, when detecting an error by performing a CRC check on data received from the reading/writing device 120, the RFID tag 210 generates response data (this data also has a CRC code for communication error detection) indicating detection of an error and returns it to the reading/writing device 120. The reading/writing device 120 stores the response data in the buffer memory 1224 and performs detection of a communication error on the response data. If no error is detected, information indicating success of reception of the response data is registered in the status register 1226. In response, the CPU 112 reads the response data (the CRC code for communication error detection has been deleted from it at this stage) from the buffer memory 1224. As a result, the CPU 112 recognizes that a communication error was detected when the RFID tag 210 received the data, and executes a necessary process such as a retry.

The preferred embodiment of the invention has been described above. Although the processes that are executed by the CPU 112 and the reading/writing device 120 have been described in detail, the processes that are executed by the RFID tag 210 have not been described in detail because they may be conventional ones.

The above description is mainly directed to writing and reading of data to and from the RFID tag 210. However, in this embodiment, detection of a error in a communication between the three units of the CPU 112, the reading/writing device 120, and the RFID tag 210 is performed and a recovery process based on the error detection is executed also for other commands to the RFID tag 210 and responses to those commands in the same manners as for writing and reading commands.

The above-described embodiment is just for illustration and various modifications are possible without departing from the scope of the invention. For example, although the embodiment employs a CRC code as an error detection code, it goes without saying that other codes may be used.

Additional features of the invention are as follows:

(1) In the image forming apparatus according to the invention, when receiving, from the storage device, a response with an error detection code to the command with the error detection code the reading/writing device performs an error detecting operation on the response with the error detection code, and the reading/writing device informs the processing unit of detection of an error if detecting the error by the error detecting operation and supplies the received response with the error detection code to the processing unit if not detecting an error by the error detecting operation; and the processing unit performs an error detecting operation on the response with the error detection code when receiving the response with the error detection code from the reading/writing device, and the processing unit accepts the response as a response to the command with the error detection code and continues control if not detecting an error by the error detecting operation and executes a second prescribed recovery process if detecting an error by the error detecting operation.

(2) In the image forming apparatus according to the invention, the first prescribed recovery process is a process of sending the command with the error detection code to the reading/writing device again.

(3) In the image forming apparatus according to the invention, the reading/writing device has a status register that is readable from the processing unit, and if detecting an error by the error detecting operation the reading/writing device informs the processing unit of the detection of the error by registering, in the status register, information indicating the detection of the error; and the processing unit is informed by the reading/writing device by monitoring the status register.

(4) The control method of an the image forming apparatus according to the invention further includes the steps of (f) the reading/writing device's performing an error detecting operation on a response with an error detection code to the command with the error detection code when receiving the response with the error detection code from the storage device; (g) the reading/writing device's informing the processing unit of detection of an error if detecting the error at step (f); (h) the reading/writing device's supplying the received response with the error detection code to the processing unit if not detecting an error at step (f); (i) the processing unit's performing an error detecting operation on the response with the error detection code when receiving the response with the error detection code from the reading/writing device; (j) the processing unit's accepting the response as a response to the command with the error detection code and continues control if not detecting an error at step (i); and (k) the processing unit's executing a second prescribed recovery process if detecting an error at step (i).

The entire disclosure of Japanese Patent Application No. 2003-389740 filed on Nov. 19, 2003 including specification, claims, drawings and abstract is incorporated herein by reference in its entirety.

1. An image forming apparatus that is mounted with a replacement component having a storage device, comprising:
a processing unit that controls operation of the image forming apparatus by executing a control program; and
a reading/writing device that writes and reads data to and from the storage device under control of the processing unit, wherein:
the processing unit generates a command with an error detection code to be transmitted to the storage device and supplies the generated command with the error detection code to the reading/writing device;
the reading/writing device performs an error detecting operation on the command with the error detection code received from the processing unit, and informs the processing unit of detection of an error if detecting the error by the error detecting operation and sends the received command with the error detection code to the storage device if not detecting an error by the error detecting operation; and
the processing unit executes a first prescribed recovery process if informed of detection of an error by the reading/writing device.

2. The image forming apparatus according to claim 1, wherein:
when receiving, from the storage device, a response with an error detection code to the command with the error detection code the reading/writing device performs an error detecting operation on the response with the error detection code, and the reading/writing device informs the processing unit of detection of an error if detecting the error by the error detecting operation and supplies the received response with the error detection code to the processing unit if not detecting an error by the error detecting operation; and
the processing unit performs an error detecting operation on the response with the error detection code when receiving the response with the error detection code from the reading/writing device, and the processing unit accepts the response as a response to the command with the error detection code and continues control if not detecting an error by the error detecting operation and executes a second prescribed recovery process if detecting an error by the error detecting operation.

3. The image forming apparatus according to claim 1, wherein the first prescribed recovery process is a process of sending the command with the error detection code to the reading/writing device again.

4. The image forming apparatus according to claim 1, wherein the reading/writing device comprises a status register that is readable from the processing unit, and if detecting an error by the error detecting operation the reading/writing device informs the processing unit of the detection of the error by registering, in the status register, information indicating the detection of the error, and wherein the processing unit is informed by the reading/writing device by monitoring the status register.

5. A control method of an image forming apparatus that is mounted with a replacement component having a storage device and comprises a processing unit that controls operation of the image forming apparatus by executing a control program and a reading/writing device that writes and reads data to and from the storage device under control of the processing unit, the control method comprising the steps of:
(a) the processing unit's generating a command with an error detection code to be transmitted to the storage device and supplying the generated command with the error detection code to the reading/writing device;
(b) the reading/writing device's performing an error detecting operation on the command with the error detection code received from the processing unit;
(c) the reading/writing device's informing the processing unit of detection of an error if detecting the error at step (b);
(d) the reading/writing device's sending the received command with the error detection code to the storage device if not detecting an error at step (b); and
(e) the processing unit's executing a first prescribed recovery process if informed of detection of an error by the reading/writing device.

6. The control method according to claim 5, further comprising the steps of:
(f) the reading/writing device's performing an error detecting operation on a response with an error detection code to the command with the error detection code when receiving the response with the error detection code from the storage device;
(g) the reading/writing device's informing the processing unit of detection of an error if detecting the error at step (f);
(h) the reading/writing device's supplying the received response with the error detection code to the processing unit if not detecting an error at step (f);
(i) the processing unit's performing an error detecting operation on the response with the error detection code when receiving the response with the error detection code from the reading/writing device;
(j) the processing unit's accepting the response as a response to the command with the error detection code and continues control if not detecting an error at step (i); and
(k) the processing unit's executing a second prescribed recovery process if detecting an error at step (i).
